(19) United States
(12) Patent Application Publication
(10) Pub. No.: US 2001/0044732 A1
(43) Pub. Date: Nov. 22, 2001

(54) Mobile data management system

(76) Inventors: Christopher T. Maus, Sagle, ID (US); Jackson B. Connolly, Post Falls, ID (US)

Correspondence Address: Michael J. Mehrman, Esq., GARDNER GROFF MEHRMAN & JOSEPHIC, P.C., Paper Mill Village, Building 23, 600 Village Trace, Suite 300, Marietta, GA, 30067, US

(21) Appl. No.: 09/892,184

(22) Filed: Jun. 26, 2001

(51) Int. Cl. G06F 17/60

(52) U.S. Cl. 705/3

(57) ABSTRACT

A medical treatment system that treats patients by using a data management system is described. Using the data management system creates several advantages including allowing emergency medical personnel additional treatment time and hospitals additional preparation time. The mobile data management system includes an interface that transfers data associated with the patient from an input device. A control system analyzes the data and generates a report that identifies medically relevant data. The management system also includes a display for viewing either the data or the report. A communication system transfers the report to a remote location before the patient arrives. Alternatively, an emergency medical treatment system for use by medical personnel in treating a patient en route to a medical facility is also described. The emergency system also includes an interface, control system, display, and communication system.

### CROSS REFERENCE TO RELATED APPLICATIONS

This patent application claims priority to commonly-owned U.S. patent application Ser. No. 09/799,479, entitled “Computerized Information Process and Retrieval System” filed on Feb. 22, 2001, which is herein incorporated by reference. This patent application relates to commonly owned U.S. patent application Ser. No. 09/436,323 filed on Nov. 8, 1999 entitled Health Monitoring and Diagnostic Device and Network-Based Health Assessment and Medical Records Maintenance System, which is herein incorporated by reference.

### TECHNICAL FIELD

The present invention relates generally to the field of medical treatment systems, and more particularly to mobile data management systems that transmit data to remote locations for more effective medical treatment of a patient.

### BACKGROUND OF THE INVENTION

Evolutions in modern health care have produced scores of highly trained medical professionals that efficiently respond to emergency situations. Generally, a dispatcher responds to an emergency call by contacting the closest available medical emergency unit. Each medical emergency unit could include an emergency medical technician (EMT) and a paramedic. After being assigned a call, the medical emergency unit assumes primary responsibility for making sure that the patient receives the proper medical treatment.

In accomplishing this objective, medical emergency units assess the status of the situation and the medical condition of the potential patient in particular. In assessing the potential patient's status, EMTs and paramedics can perform a cursory examination and begin collecting background information from either the victim or witnesses. The background information can include the victim's name, type of insurance, medical history, and circumstances surrounding the call.

After assessing the status of the patient, medical personnel may decide if the patient should be transported to a medical facility. When the medical condition of the patient warrants hospital treatment, these individuals transport the patient to the medical facility. While in route, an EMT can complete several procedures designed at stabilizing the patient. These procedures could include measuring the patient's vitals such as pulse, respiration, blood pressure, and heart rate. In addition, medical personnel can perform other medical procedures such as administering cardiopulmonary resuscitation or stabilizing the patient's neck. Consequently, medical personnel manually complete multiple tasks including transporting the patient, recording treatment administered to the patient, and notifying the medical facility of the patient's expected arrival. In notifying the medical facility, emergency medical personnel may give a general synopsis of the patient's condition to the medical facility as well as surrounding circumstances. For example, a paramedic may inform the hospital that the victim has a gunshot to the head and is unconscious.

When the patient arrives at the medical facility, an EMT may begin briefing the hospital staff on the patient's medical condition. For example, the EMT could begin reciting the patient's name, vital signs, circumstances surrounding the trauma, treatment, as well as some of the patient's background information. Because the patient's medical condition could be life threatening at this stage, effective conveyance of this information from emergency medical personnel to the hospital staff can be particularly important.

Once briefed, the hospital staff can appropriately treat the patient. Because the medical facility may have only received a general synopsis of the patient's condition, this step may involve an exploration of the possible causes for the patient's physical condition as well as acquiring additional information from either the victim or the victim's family. For example, the hospital could spend valuable time identifying present medical conditions aggravated by the present trauma.

Despite the development in the area of medical treatment system, most conventional solutions remain primarily manual and include a great potential for error. For example, relevant medical data could be omitted during the conveyance of information from the emergency medical personnel to the hospital personnel. In addition, implementation of conventional treatment solutions often results in considerable time losses. For example, giving the medical facility only a general synopsis of the patient's most critical issues could result in an extended exploration time. Hospital personnel could spend critical time determining the patient's medical history, as well as current medical problems. For a victim that lost a considerable amount of blood between the occurrence of the trauma and arrival at the hospital, expending additional time could be fatal. Thus, a need still exists for a more effective medical treatment system that reduces the potential for error while minimizing time losses by better preparing the hospital.

### SUMMARY OF THE INVENTION

The present invention meets the needs described above in a medical treatment system that more effectively treats patients by using a data management system. The unique design of the data management system provides a compact portable terminal and transceiver that can both transmit and receive data from remote locations. Using the data management system creates several advantages over conventional treatment methods including allowing emergency medical personnel more time for treating the patient, enabling user customization of time saving features, and creating more time for hospitals to prepare for arriving traumas.

To save time during treatment, emergency medical personnel can use a multipurpose card, medical devices, and input devices with the data management system. Because multipurpose cards, or smartcards, often include secure data storage areas, the card can store background information for a patient such as name, photograph, primary care physician, blood type, living will, address, and insurance information. Once the smartcard is inserted, the data management system can efficiently extract this information from the card without beginning a lengthy information acquisition period. For example, an EMT can learn that a patient has diabetes and alter treatment accordingly. In addition, a medical device interface within the data management system can connect this system to various commercially available medical devices. Thus, the data management system electronically records the patient's vitals with limited involvement by emergency medical personnel. Similarly, the data management system includes an input device interface that can connect input devices, which aid medical personnel in recording administered treatment. Using a voice recognition device, medical personnel can simply verbalize administered treatment and the data management system electronically records this information. By entrusting some of the administrative tasks, such as data collection and recordation associated with treating a patient to the data management system, medical personnel can focus more time on actually treating the patient.

Another advantage resulting from use of the data management system allows user customization of the desired amount of automation. Users can indicate if reports or designated forms should be automatically constructed. For example, the data management system can automatically generate a hospital admission form when it receives background information. Similarly, this system could also automatically generate a triage report after receiving medical readings and administered treatment. Alternatively, a user could specify that a location report, which uses a global positioning system, should not be generated until medical personnel specify both an originating destination and a final destination. Users can also specify if reports should be automatically transmitted to the receiving hospital or periodically updated. For example, a user could specify that a location report, which includes an estimated time of arrival, should be sent when the emergency vehicle is at least fifteen miles from the medical facility and be updated every three minutes.

Finally, using the data management system results in producing more prepared hospitals that can more effectively treat patients. Because the data management system transmits data to the medical facility before the patient arrives, hospital personnel can better assess the victim's condition before arriving at the hospital. For example, the hospital can download physician notes regarding the patient from a computer after receiving the patient's name, primary care physician, and medically relevant conditions from a transmitted report. By knowing medically relevant patient information, the hospital can better prepare for the patient, by gathering resources, requesting additional medical staff, and reassigning hospitals beds in the trauma center. Consequently, the hospital staff can more effectively service arriving victims. Moreover, the hospital can restrict ambulances from arriving when the hospital reaches its capacity. For example, a hospital that received twenty children with serious injuries resulting from collision of school buses can notify paramedics that it is fully occupied.

Generally described, the invention is a mobile data management system for use in administering medical treatment to a patient. An interface transfers data associated with the patient from an input device. A control system analyzes the data and generates a report that identifies medically relevant data. This medically relevant data aides in the treatment of the patient. The invention also includes a display for viewing either the data or the report. A communication system transfers the report between data management system and a remote location before the patient arrives.

Alternatively, the invention is an emergency medical treatment system for use by medical personnel in treating a patient en route to a medical facility. An interface transfers medically relevant data associated with the patient from at least one device. A control system analyzes the data and generates a report in response to processing at least a portion of the data received by the interface. The emergency medical treatment system includes a display for viewing the report, the data, or some combination thereof. A communication system transfers the report across a network to the medical facility before the patient arrives.

The invention also includes a method for treating a patient en route to a medical facility using a mobile data management system. In one step, the method receives medically relevant data associated with the patient. At least a portion of the data is processed. At least one report is generated in response to processing the data. The report is transferred between the treatment system and the medical facility.

In view of the foregoing, it will be appreciated that the data management system avoids the drawbacks of prior treatment systems. The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is a functional block diagram of an environment in which the data management system of the present invention can be used.

FIG. 2A is a function block diagram of the data management system of FIG. 1 illustrating some of the components of the data management system of FIG. 1.

FIG. 2B is perspective view on one embodiment of the data management system of FIG. 2A illustrating a cradle.

FIG. 3 is a logic flow diagram for a method of more effectively treating a patient using the data management system of FIG. 2.

### DETAILED DESCRIPTION OF THE EMBODIMENTS

The present invention may be embodied in a data management system that more effectively treats patients by using a data management system. Generally, the data management system receives and processes medical information from a host of sources. In processing the medical information, this system could produce several reports based on the received medical information. By transmitting these reports to a remote location, the data management system can send reports before the patient arrives. Consequently, the remote location could use these reports in more effectively treating the patient. To enable more effective treatment, the data management system uses an interface, control system, display, memory storage element, GPS device, and a communication system. Alternatively, the data management system can use a combination of any of these components.

The data management system includes an interface that receives data associated with the patient. Generally, the interface includes different types of interfaces that receive information from various devices. One such interface could be a medical device interface that uses a combination of hardware and software for receiving data. This type of interface could receive information from a host of commercially available medical devices such as a thermometer, blood pressure cuff, heart monitor, fetal monitor, pulse-ox machine, glucometer, ventilator, and other suitable devices. For example, a glucometer can transfer a compiled list of readings to the data management system. In response, the data management system can produce and transmit a report that identifies trends, for example, associated with the recorded glucose readings. Thus, the physician can more effectively treat the patient using this report.

Instead of the medical device interface, the data management system can include a data drive or an input device interface. Using a data drive enables transfer of data between the data management system and a smart card, floppy disk, optical disk, or some other suitable device. For example, a smartcard could store a parental consent, do not resuscitate order, and transfusion instructions. For security purposes, the smart card could include features that restrict access of the stored data to medical personnel only. Alternatively, the input device interface of the data management system can transfer data from input devices such as a keyboard, touch sensitive screen, voice recognition device, touch pad, or some other suitable input device. Using input devices enable recording of information not necessarily associated with a device. For example, a voice recognition device can record that the paramedic inserted an IV into the patient. Because the input device interface can work in concert with the medical device interface, the data management system can evaluate the variation of the heartbeat of the patient since insertion of the IV.

In addition to the interface, the data management system can also include a control system, display, and memory storage element. The control system can synthesize the received data and produce the report. Through a combination of hardware and software, users can specify both the type of report and how often it should be generated. For example, a user can specify that the control system prepare one admission form for each patient that includes the patient's name, address, insurance information, and nearest relative. After producing the report, the control system can present the report for viewing using a display. The display could be a monitor, television, active matrix liquid crystal display, or a dual scan liquid crystal display. For example, the data management system could include a monitor jack that enables connection with commercially available computer monitors. The data management system also includes a memory storage element that could be random access memory (RAM), removable RAM, programmable read only memory (PROM), electrically erasable PROM, or some other suitable memory storage element. Using the memory storage element, the control system can store previously processed data for subsequent retrieval. For example, the control system could store a triage report for the patient that indicated the patient's blood pressure was 146/102. Five minutes later, the control system can receive a blood pressure of 150/110 from the interface. By retrieving the blood pressure from the memory storage element, the control system can prepare a second triage report for this patient that includes the present blood pressure rate as well as percent difference. Thus, the new triage report would also indicate that systolic pressure increased by 3% while the diastolic pressure increased by 7%.

Using a communication system, the data management system transfers generated reports to remote locations. The communication system could be an Ethernet or a wireless data network. The wireless data network could include a cellular system or a closed circuit satellite system, such as one used by Skytel. In addition, the data management system could include a global positioning device that easily identifies the location of the data management system by sending and receiving signals from a host of satellites. The global positioning device could be a commercially available device such as the Street Pilot III manufactured by Garmin. By transferring location information to the medical facility, medical personnel can appropriately prepare for treatment. For example, transferring a triage report can inform hospitals of the status of a patient before the patient arrives. Consequently, medical personnel at these remote locations can monitor a patient's progress.

The design of the data management system enables use of this system in a variety of applications for both immediate and remote monitoring of a patient's condition. Using the data management system within an emergency medical treatment system, medical personnel can treat a patient while en route to a medical facility. As medical personnel such as paramedics and emergency medical technicians enter the trauma cite, they begin ascertaining the events surrounding the victim's injury. Due to the compact design, medical professionals can record the results of these inquiries using one or more of the input devices associated with the data management system. While continuing to treat the patient inside the ambulance, the data management system can record associated readings from connected medical devices. Using readings from a global positioning device, medical devices, and input devices, the data management system transmits to a hospital a triage report, location report that includes an estimated time of arrival, and an admission form. Consequently, the hospital can appropriately prepare for and anticipate the arrival of the patient.

Alternatively, the data management system can be used in diabetes monitoring. Typically, physicians request that patients record their glucose level before each meal. Periodically, a physician may review these readings and adjust the prescribed medication dosage accordingly. Using the invented data management system, the physician can receive a report that analyzes these logged readings and identifies any related trends. In response, the physician can electronically request that the patient modify their dosage by transmitting the new dosages to the data management system. In an alternative embodiment, the data management system may periodically transmit a report to the patient's physician. Subsequently, the physician may transmit a message to the data management system that indicates the patient should come in immediately for the first glucose reading above 300. Moreover, programming in the data management system can set an alert for this glucose level. Hence, this system allows effective treatment of a diabetic patient without the considerable time loss associated with extended or recurring doctor visits. Because this system records readings and monitors remotely, the physician remains well apprised of the patient's condition before arrival in the physician's office.

In addition, the data management system can remotely monitor a pregnant woman. As a pregnant woman approaches the end of the term, certain vitals signs become particularly important. For example, a physician may monitor the mother's blood pressure, heart rate, and contraction frequency more closely. If the mother had a heart monitor and a blood pressure cuff at home, the data management system could produce a report using these medical readings and transmit it to the mother's obstetrician-gynecologist (OB-GYN). As the OB-GYN analyzes this report, he can more effectively prepare for the mother's delivery. As previously described, the data management system can create an alert based on criteria received from the OB-GYN that indicates which combination of contraction frequency, heart rate, and blood pressure readings warrant the mother's immediate departure for the hospital. Similarly, that data management system can remotely monitor dialysis patients and cancer patients.

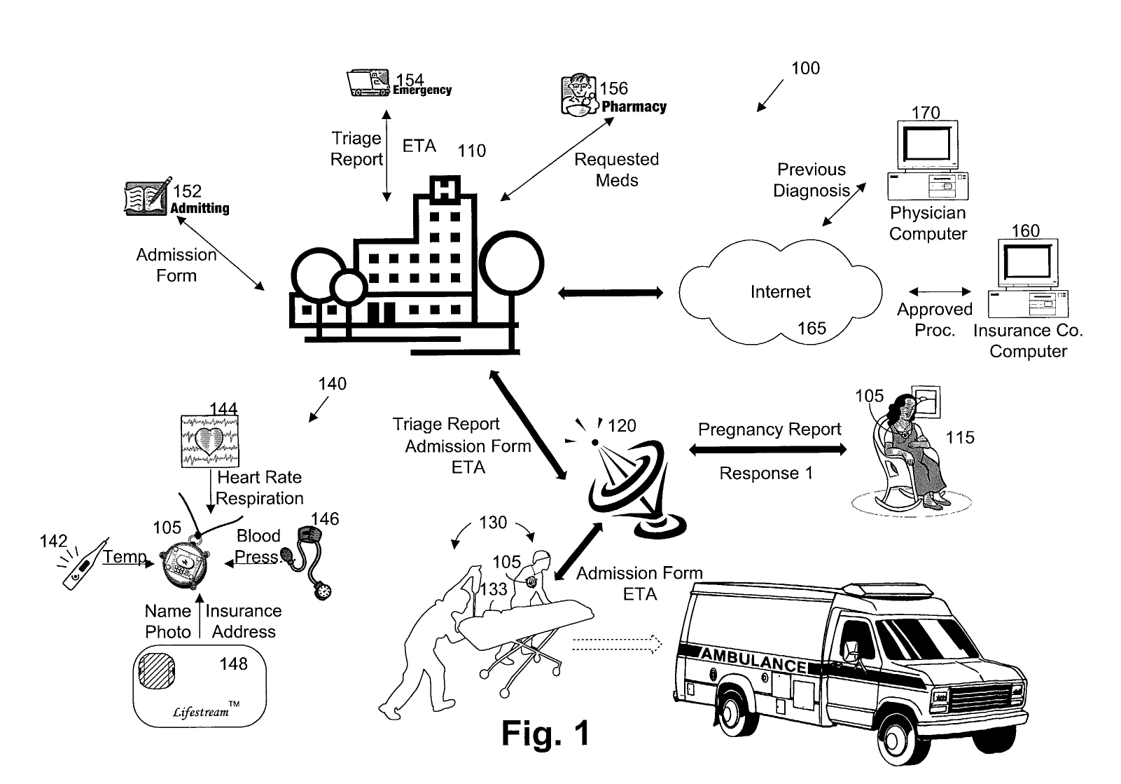

Turning now to the figures, in which like numerals refer to like elements through the several figures, FIG. 1 is a functional block diagram of an environment in which the data management system of the present invention can be used. Within the environment 100, the data management system 105 controls the transfer of information from the patient's current location to a medical facility, such as a nursing home, physician's office, or a hospital 110. In one application, a pregnant woman 115 records medical data using commercially available medical devices, such as a belt type heart monitor. The data management system 105 receives the readings from a heart monitor and produces a pregnancy report that indicates the status of both the mother and child. For example, the pregnancy report can indicate the mother's heart rate, mother's blood pressure, baby's heart rate, and frequency of contractions. The data management system can transmit this report to the hospital 110 using the satellite 120. The hospital 110 can transmit a response, illustrated response 1, back to the mother 115 requesting that the mother 115 come to the hospital 110 when the contractions are three minutes apart and her blood pressure is at least 130/85. After receiving this response, the mother 115 can respond accordingly.

Instead of the patient, medical personnel 130 can enter information for the patient 133 using the data management system 105. Once inside the ambulance 135, the medical personnel 130 can connect several types of medical devices 140 to the data management system. These devices could include a thermometer 142, heart monitor 144, blood pressure cuff 146, and a data accumulation device, shown as a smartcard 148. Hence, the data management system 105 can receive temperature readings, heart rate readings, as well as blood pressure readings. The smartcard 148 functions similar to the smartcard described in commonly owned U.S. patent application Ser. No. 09/799,479 entitled “Computer Information Process and Retrieval System,” which is hereby incorporated by reference. Moreover, the smartcard 148 can be used in conjunction with the secure records maintenance system described in commonly owned U.S. patent application Ser. No. 09/436,323 filed on Nov. 8, 1999 entitled Health Monitoring and Diagnostic Device and Network-Based Health Assessment and Medical Records Maintenance System,” which is also herein incorporated by reference.

Hence, the data management system 105 can receive from the smartcard 148 various types of background information regarding the patient. This information could include the patient's name, photograph, age, weight, blood type, physician's name, relative's name, present medical conditions, organ donor status, living will, fingerprint, DNA, insurance, medical history, legal documents, treatment authorizations, medical power of attorney, as well as date of last up date. The patient could receive either a partially programmed smartcard or a fully programmed smartcard. Either type of smartcard could include a first area secured by a global unique identifier (GUID) that includes various types of non-medical information, such as product or rental information. However, this card could also include a second area secured by a second GUID that contains the medical information described above. Medical professionals that possess the second GUID can access the medically relevant information stored on the smartcard 148. For a more detailed explanation of the use of the GUID, the reader is referred to either of the incorporated patent applications.

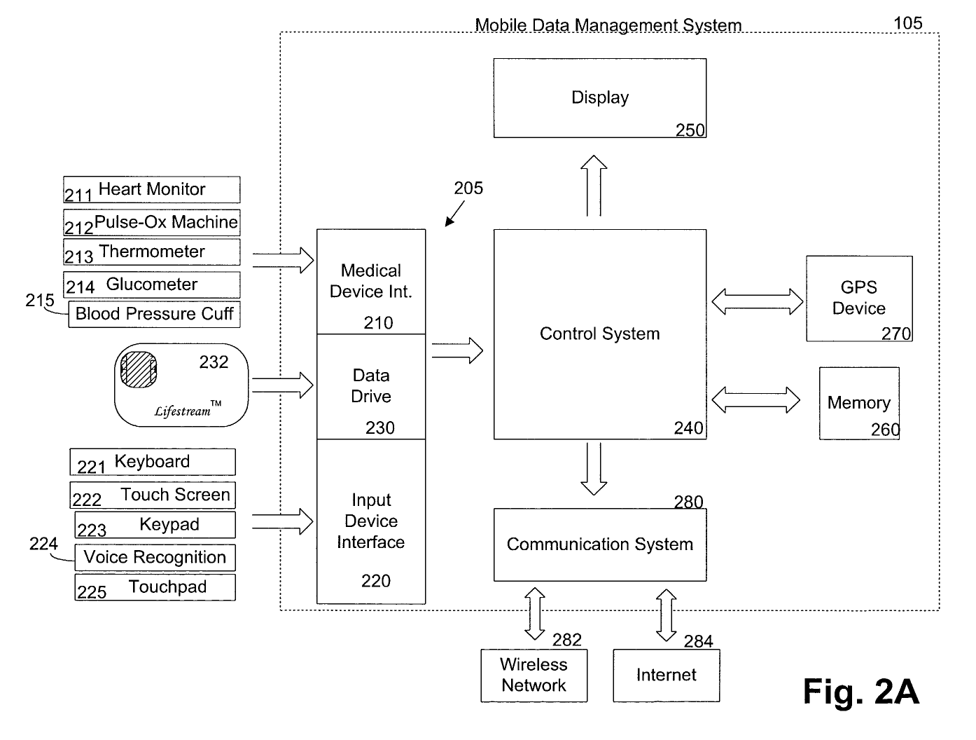

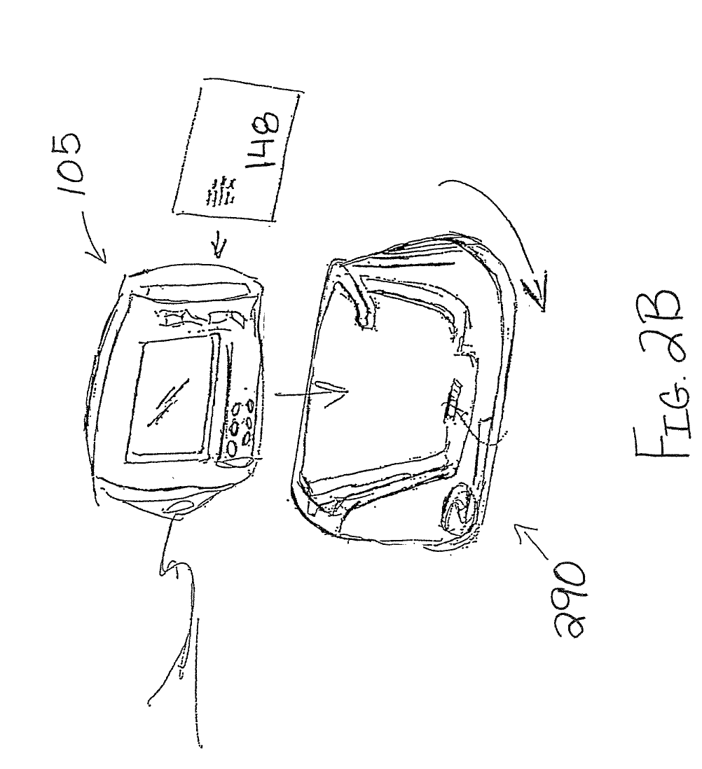

When the data management system 105 receives the information from the devices 140, it processes the information and subsequently generates a collection of reports. For example, the data management system 105 can generate an admission form by using the name, address, and insurance information received from the smartcard 148. To generate a triage report, the data management system 105 can receive treatment data entered by medical personnel. For example, medical personnel 130 can speak the treatment administered to the patient 133 using a voice recognition device, as described with reference to FIG. 2. In addition, the data management system 105 receives readings from medical devices. Using the treatment data in combination with the temperature, blood pressure, and heart rate, the data management system 105 can generate a triage report for the patient 133. The triage report can indicate the patient's vital signs, type of injury, and administered treatment. When the data management system 105 includes a global positioning device, this system can also calculate the estimated time of arrival (ETA) of the ambulance 136.

By transmitting the triage report, admission form, and ETA to the hospital 110 before the patient 133 arrives, this hospital can more effectively prepare for the patient's arrival. The hospital 110 can route the admission form to its admitting department 152 and the triage report and ETA to its trauma center 154. Transmitting the admission form to admitting 152 can significantly reduce the amount of paperwork that must be completed by the patient 133 or the patient's family at the time the patient arrives. By receiving the triage report and ETA, the trauma center 154 can insure that it has the proper staff to effectively treat the patient 133. If the triage report includes a medicinal recommendation, the hospital 110 can request medicine from its pharmacy 156. Alternatively, the pharmacy 156 can send the requested medicines to the trauma center 154 before the patient arrives.

Once the patient arrives, medical personnel at the hospital 110 can begin effectively treating the patient 133. At some point, the medical personnel may realize a need for approval from the patient's insurance company for a certain procedure. Consequently, the hospital 110 can contact the Insurance Company's computer system 160 using a communication media, such as the Internet 165. The computer system 160 could respond by sending a list of approved procedures based on the patient's coverage. In addition, the hospital staff may want to know if the patient's physician made a previous diagnosis relating to this issue. Similarly, the hospital 110 could contact the physician's computer system 170. In response, the physician's computer 170 could transmit the latest physician's diagnosis. In one alternative embodiment, the smartcard 148 could store the list of approved procedures and previous diagnosis. In another alternative embodiment, the data management system 105 can download information from either the computer system 160 or the computer system 170. Armed with this information, the medical staff at the hospital 110 can more affectively treat the patient 133.

FIG. 2A is a functional block diagram illustrating some of the components of the data management system 105. The data management system 105 includes several interfaces 205 that control the transfer of data between the data management system 105 and numerous devices. The medical device interface 210 can receive information from various types of medical devices such as a heart monitor 211, pulse-ox machine 212, thermometer 213, glucometer 214, and blood pressure cuff 140. These devices can produce medical readings such as heart rate, pulse-oxygen level, temperature, amount of sugar in a person's blood, and blood pressure. Because the data management system 105 can interface with commercially available devices, it can be used in a physician's office, home, ambulance, hospital, nursing home, as well as a host of other locales. An input device interface 220 can receive data from a variety of input devices, which include a keyboard 221, touch sensitive screen 222, keypad 223, voice recognition device 224, and touch pad 225. Using one of the input devices 140, an individual such as a paramedic, physician, nurse, pregnant woman, or diabetic patient, can easily record information. For example, a paramedic could key in treatment administered while en route to the hospital using the touch-sensitive screen 222. Alternatively, a pregnant woman could verbally record the number of contractions using the voice recognition device 224. The interface 205 of the data management system 105 can also include a data drive 230 that receives data from various removable storage media such as an optical disk, floppy disk, or smartcard 232. Using the interfaces 205, the data management system 105 can either transmit data to or receive data from a host of devices.

As the interfaces 205 transfer data to a control system 240, this system analyzes the received data and correspondingly prepares a report that details the result of the analysis. For example, the control system 240 could generate a triage report that includes the patient's heart rate and blood pressure readings received from the medical device interface. In addition, this triage report could include the patient's living will as received from smartcard 232 and administered treatment as received from the input device interface 220. The control system 240 produces a single triage report that identifies relevant medical readings, treatment, and patient wishes. Consequently, a hospital that receives this information can more effectively treat the patient.

The control system 240 can present the received data and any generated reports for viewing using the display 250. As mentioned above, the display 250 could be an active matrix liquid crystal display. By presenting this information for viewing, individuals using the data management system 105 can easily review readings received from several medical devices in a single location. For example, an emergency medical technician can monitor the patient's heart rate, blood pressure and glucose level by using the display 250. Moreover, the control system 240 can include software that allows user customization of the manner in which the data is displayed. For example, a paramedic may specify that blood pressure and heart rate should be displayed right below the living will.

The data management system 105 also includes a memory device 260 that can store readings or reports for later use. As the control system 240 produces reports, it can transfer these reports to memory 260. Subsequently, the control system 240 can compare more recently generated reports with the reports stored in memory. For example, the control system 240 may generate a triage report R₁ at time t₁ and store this report in memory 260. A minute later, the control system 240 can produce triage report R₂ and retrieve triage report R₁ from memory 260. By comparing these reports, the control system 240 may append report R₂ to indicate the percentage that the patient's blood pressure dropped in sixty seconds.

Within the data management system 105, a global positioning system (GPS) device 270 effectively determines the location of this data management system. As the GPS device 270 transfers this information to the control system 240, the control system 240 can produce a location report that indicates the distance between the data management system 105 and a desired location, such as a medical facility. For example, the location report could include the estimated time of arrival of an ambulance at a hospital. In addition, this location report could indicate the route that the paramedics will follow in traveling to the hospital, as well as weather and traffic reports. Like the triage report, the control system could also store this location report in memory 260.

A communication system 280 transfers data between the data management system and remote locations. To transfer data, the communication system 280 includes an interface for a wireless data network 282. Using this interface, the data management system 105 can either transmit or receive data from remote locations. For example, the communication system 280 can transmit a triage report to the hospital 110. In addition, this communication system can receive an approval response from the hospital indicating that they are capable of handling the patient. In transmitting the report, the communication system 280 could use the overhead data channel instead of using a frequency in the voice range. Alternatively, the data management system can transmit the report using the Internet 284. For example, the data management system 105 can include a cradle 290 as illustrated in FIG. 2B. Once connected, this system can automatically transfer information to a connected computer system. For example, the data management system 105 can use the cradle 290 in sending a triage report to a remote location. By including the communication system 280, the data management system 105 can both transmit and receive information from remote locations.

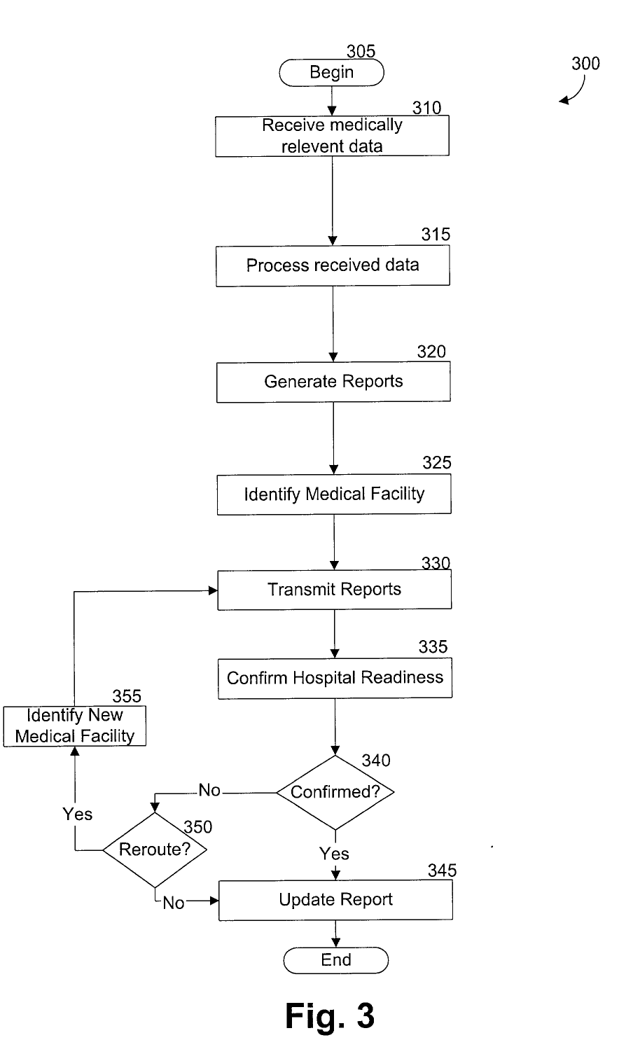

FIG. 3 is a logic flow diagram of a routine for more effectively treating a patient using the data management system of FIG. 2A. Routine 300 begins at step 305. Step 305 is followed by step 310, in which the routine 300 receives medically relevant data using the interfaces 205. As explained with reference to the interfaces 205, the medically relevant data can include a living will, insurance information, treatment data, as well as other information. Step 310 is followed by step 315, in which the routine 300 processes the received data. Generally, this processing can include comparing received medical readings with standard medical readings as well as analyzing administered treatment. Step 315 is followed by step 320, in which the routine 300 generates reports based on the received data. These reports can include admission forms, triage reports, and location reports. In an alternative embodiment, the routine 300 could include a decision step between step 315 and step 320 that allows specification by a user of whether he wants a report automatically generated.

Step 320 is followed by step 325, in which the routine 300 identifies a medical facility. In completing this step, the routine may make this decision in light of several variables including proximity, type of trauma, as well as other suitable criteria. Step 325 is followed by step 330, in which the routine 300 transmits the generated reports to the identified medical facility. This transmission could be done using a wireless network. In step 335, the routine 300 confirms the hospital's readiness. This routine can complete this step by requesting that the hospital respond to the transmitted report. For example, a hospital may respond to the triage report by indicating that power outages prevent it from treating additional patients.

Step 335 is followed by the step 340, in which the routine 300 determines if the hospital's readiness has been confirmed. When the hospital confirms its readiness, the “Yes” branch is followed from step 340 to step 345. In step 345, the routine 300 updates the report. By updating the report, the routine 300 assures that the medical facility has access to the most recent patient information. If the hospital does not confirm that it is ready, the “No” branch is followed from step 340 to step 350. In step 350, the routine 300 determines if it should direct medical personnel to reroute the trauma to another facility. Factors affecting this decision could include whether the hospital responded, the length of time since the request was sent, the proximity of another hospital, as well as other factors. If the routine 300 determines that it should not reroute this trauma, the “No” branch is followed from step 350 to step 345. Otherwise, the “Yes” branch is followed from step 350 to step 355. In step 355, the routine 300 identifies a new medical facility. Step 355 is followed by step 330 in which the routine 300 transmits the report to the newly identified hospital.

In view of the foregoing, it will be appreciated that the present invention provides a data management system for use in administering medical treatment to a patient. It should be understood that the foregoing relates only to the exemplary embodiments of the present invention, and that numerous changes may be made therein without departing from the spirit and scope of the invention as defined by the following claims.

The invention claimed is:

1. A mobile data management system for use in administering medical treatment to a patient, comprising:
an interface for receiving data associated with the patient from a device;
a control system for analyzing the data and generating a report that identifies medically relevant data that will aide in treating the patient;
a display for viewing either the data or the report; and
a communication system for transferring the report between the data management system and a remote location, wherein the report is transferred to the remote location before the patient arrives.

2. The system of claim 1 further comprising a memory storage element for storing previously processed data for subsequent retrieval.

3. A global positioning system for use with the management system of claim 1, comprising:
a global positioning device that produces data in response to receiving signals from a plurality of remote satellites; wherein
the control system generates a second report in response to receiving the position data from the global positioning device and the communication system transmits the second report to the remote location before the patient arrives.

4. The system of claim 1 wherein the interface is either a medical device interface for receiving the readings from medical devices or a data drive for receiving the biographical data from a data accumulation device.

5. The system of claim 4 wherein the data accumulation device is a smart card and the communication system is either the Internet or a wireless data network.

6. The system of claim 1 wherein the device is an input device is selected from the group consisting of a touch-sensitive screen, keyboard, or numeric keypad.

7. The system of claim 1 wherein the remote location is a medical facility and the communication interface transmits the report to the medical facility before the patient arrives at the medical facility.

8. A data accumulation device for transmitting biographical data to the management system of claim 1.

9. A medical device for transmitting at least one medical reading to the management system of claim 1.

10. The system of claim 1 for use by either medical personnel or the patient.

11. The system of claim 1 further comprising a cradle for connecting the data management system to a remote computer system, wherein the control system processes data received from the remote computer system.

12. An emergency medical treatment system for use by medical personnel in treating a patient en route to a medical facility, comprising:
an interface for receiving medically relevant data associated with the patient from at least one device;
a control system for analyzing the data received by the interface and for generating a report in response to processing at least a portion of the data received by the interface;
a display for viewing the data, report, or some combination thereof, and
a communication system for transferring the report between the treatment system and the medical facility wherein the report is transferred across a network to the medical facility before the patient arrives.

13. The treatment system further comprising a multipurpose card for temporarily storing and transporting the medically relevant data.

14. A global positioning system for use with the management system of claim 10, comprising:
a global positioning device that produces position data in response to receiving signals from a plurality of remote satellites; wherein
the control system produces a second report in response to receiving the position data from the global positioning device and the communication system transmits the location report to the medical facility.

15. The treatment system of claim 12 wherein the interface includes an input device selected from the group consisting of a touch-sensitive screen, keyboard, or numeric keypad.

16. The treatment system of claim 12 wherein the medical device is selected from the group consisting of a blood pressure cuff, pulse-ox machine, thermometer, heart monitor, and glucometer.

17. The system of claim 12, wherein the report includes either a triage report or an admission form.

18. A computerized method for treating a patient en route to a medical facility using an emergency medical treatment system, comprising the steps of:
receiving medically relevant data associated with the patient;
processing at least a portion of the data;
generating at least one report in response to processing a portion of the data; and
transferring the report between the treatment system and the medical facility.

19. The method of claim 18 wherein the report is transferred before the patient arrives.

20. The method of claim 18 further comprising receiving a response from the remote location based on the transmitted report.
